(19) United States
(12) Patent Application Publication
(10) Pub. No.: US 2010/0062216 A1
(43) Pub. Date: Mar. 11, 2010

(54) PACKAGING SHEET FOR ABSORBING BIOFLUID AND PRODUCT MANUFACTURED THEREFROM

(76) Inventor: Jong Seok Kwak, Daegu (KR)

Correspondence Address: F. CHAU & ASSOCIATES, LLC, 130 WOODBURY ROAD, WOODBURY, NY, 11797, US

(21) Appl. No.: 12/524,658

(22) PCT Filed: Jan. 24, 2008
(86) PCT No.: PCT/KR08/00449

§ 371 Date: Jul. 27, 2009

(30) Foreign Application Priority Data
Jan. 31, 2007 (KR) 10-2007-0010139

(51) Int. Cl. B32B 3/10; B32B 38/00

(52) U.S. Cl. 428/138; 156/217; 156/290

(57) ABSTRACT

This invention relates to a method of manufacturing a packaging sheet for absorbing biofluid and a packaging sheet product manufactured therewith, in which the packaging sheet includes three layers, between two layers of which a biofluid absorption fabric is disposed, so that food is separated from the biofluid absorption fabric at the time of packaging the food, and thereby, in a state in which the food does not come into direct contact with the biofluid absorption fabric, drips oozing from the food are absorbed into the biofluid absorption fabric via absorption holes, thus maintaining optimal freshness of the packaged food.

### TECHNICAL FIELD

The present invention relates to a method of manufacturing a packaging sheet for absorbing biofluid and a packaging sheet product manufactured therewith, and more particularly, to a method of manufacturing a packaging sheet for absorbing biofluid and a packaging sheet product manufactured therewith, in which drips (biofluid) oozing from the surface of drippy food such as meat or fish are absorbed, thus preventing the discoloration of food (meat, fish, and vegetables) due to the drips oozing from the food to thereby prevent the degradation in quality of the food for a long period of time.

### BACKGROUND ART

Generally, in cases where food, such as meat, fish, or vegetables, which is vacuum-packaged in a gas-impermeable bag, is stored at refrigeration temperatures or in a frozen state and is then thawed, biofluid, which is liquid in drips, oozes from the food and thus accumulates in the space defined between the food and the gas-impermeable bag. As such, when the food packaged in the gas-impermeable bag is brought into contact with the oozed drips, the quality thereof is degraded (e.g., the color thereof is changed), drastically reducing the value of the product.

When the portion of the food packaged in the gas-impermeable bag, which is discolored due to contact with the oozed drips, is removed, problems occur in which the total yield of the food is decreased and drips foster the growth of microbes, thus undesirably shortening the food shelf life. Thus, attempts to develop methods of removing drips from food have been made, and such methods include packaging food so that the food is brought into contact with a liquid-absorbing material in a sheet form for absorbing drips oozing from the food during the storage.

The liquid-absorbing material used therefor is a capillary liquid-absorbing material, for example, paper pulp which has a hydrophilic surface and is capable of absorbing and retaining drips through a capillary phenomenon, called a polymeric water absorbent and a composite material thereof. However, the capillary liquid-absorbing material has low strength as a sheet material, and the polymeric water absorbent is typically provided in the form of powder or granules, thus undesirably causing problems at the time of coming into contact with food.

The liquid-absorbing material is coated with a liquid-permeable thin film (e.g., pad, nonwoven fabric) and is used as a liquid-absorbing sheet. In the case where food is vacuum-packaged with a gas-impermeable thin film, chilled and then transported, the liquid-absorbing sheet covers most of the surface of the food or is placed below the bottom surface of the food. This is because drips oozing from the food remain on the bottom portion of the packaging material and in the hollow portion of the food, due to gravity and vibration during transport, even when food is vacuum-packaged with a gas-impermeable sheet. The liquid-absorbing sheet is appropriately located to absorb drips, which is the main purpose of the liquid-absorbing sheet, thereby preventing drips from approaching the food.

However, in the case where the liquid-permeable thin film, which constitutes part of the outer surface of the liquid-absorbing sheet, is brought into contact with the food, the liquid-absorbing sheet excessively absorbs not only drips present in the space between the food and the gas-impermeable thin film but also internal water from the surface of the food in contact with the liquid-absorbing sheet, thus rapidly drying the food, resulting in degraded quality.

Further, in conventional techniques, in the case where the liquid impermeable thin film, which constitutes part of the liquid-absorbing sheet, is brought into contact with the food, when the liquid-absorbing sheet, in particular, the liquid impermeable thin film, is disposed at the hollow portion of the food or beneath the bottom portion of the food, it is impossible to absorb drips oozing from the food at the contact surface thereof. Moreover, the drips are in contact with the food for a long period of time, thus making it impossible to sufficiently absorb such drips.

### DISCLOSURE

### Technical Problem

Accordingly, the present invention has been devised to solve the problems encountered in the related art, and a first object of the present invention is to provide a method of manufacturing a packaging sheet for absorbing biofluid and a packaging sheet product manufactured therewith, in which the packaging sheet is composed of three layers, between two layers of which a biofluid absorption fabric is disposed, so that food is separated from the biofluid absorption fabric at the time of packaging the food, and thereby, in a state in which the food does not come into direct contact with the biofluid absorption fabric, drips oozing from the food are absorbed into the biofluid absorption fabric through absorption holes, thus maintaining optimal freshness of the packaged food.

A second object of the present invention is to provide a packaging sheet for absorbing biofluid, which is composed of three layers, between two layers of which a biofluid absorption fabric is disposed, so that food is separated from the biofluid absorption fabric at the time of packaging the food, thereby preventing contact between the food and drips oozing from the food, thus preventing the discoloration of the food and the degradation of quality thereof for a long period of time.

A third object of the present invention is to provide a packaging sheet for absorbing biofluid, which is composed of three layers, between two layers of which a biofluid absorption fabric is disposed, thereby overcoming conventional problems in which a biofluid absorption fabric is manually placed in the packaging sheet, for example, burdens of time and personnel expense, and enabling the automation of a packaging process.

A fourth object of the present invention is to provide a packaging sheet for absorbing biofluid, which is composed of three layers, between two layers of which a biofluid absorption fabric is disposed, so that food is separated from the biofluid absorption fabric at the time of packaging the food, thereby solving conventional problems related accidents in which a consumer does not notice the presence of a biofluid absorption fabric, which is typically provided under food, and cooks the fabric along with the food.

A fifth object of the present invention is to provide a packaging sheet for absorbing biofluid, which is composed of three colored layers, between two layers of which a biofluid absorption fabric is disposed, so that food is separated from the biofluid absorption fabric at the time of packaging the food, thereby covering the biofluid absorption fabric into which drips (biofluid) are absorbed to thus overcome an uncomfortable feeling in response to the sight of such fabric, which may otherwise occur.

A sixth object of the present invention is to provide a packaging sheet for absorbing biofluid, which is composed of three layers, between two layers of which a biofluid absorption fabric is disposed, and also, absorption holes for absorbing drips oozing from food are formed in the inner layer, and thus, in a state in which food does not come into direct contact with the biofluid absorption fabric, drips oozing from food are absorbed into the biofluid absorption fabric through the absorption holes, thereby preventing the excessive absorption of water from food and the rapid drying of food.

### Technical Solution

In order to accomplish the above objects, a first embodiment of the present invention provides a method of manufacturing a packaging sheet for absorbing biofluid, suitable for absorbing drips oozing from food, including meat, fish, and vegetables, packaged therein, comprising (a) forming a plurality of absorption holes in a first half of a first film having a predetermined size; (b) disposing a biofluid absorption fabric for absorbing drips oozing from the food on a second half of the first film, but not on the first half of the first film having the absorption holes formed as in (a); (c) folding the first film in half so that the first half of the first film having the absorption holes is positioned on the second half of the first film on which the biofluid absorption fabric is disposed, as in (b); (d) adhering sides of the first film folded in half as in (c); (e) placing a second film, having the same size as the half of the first film, on the outer surface of the first half of the first film folded in half and having the adhered sides as in (d), having the absorption holes; and (f) adhering three sides of the second film, other than one side thereof, to the first film in the state of (e), thus manufacturing a packaging sheet for packaging the food including meat, fish, and vegetables.

A second embodiment of the present invention provides a method of manufacturing a packaging sheet for absorbing biofluid, suitable for absorbing drips oozing from food, including meat, fish, and vegetables, packaged therein, comprising (a) disposing a biofluid absorption fabric for absorbing drips oozing from the food on a first film having a predetermined size; (b) forming a plurality of absorption holes in a second film having the same size as the first film used in (a), and then placing the second film on the first film so that the biofluid absorption fabric is disposed between the first film and the second film; (c) adhering sides of the first film and the second film in the state of (b); (d) placing a third film, having the same size as the second film placed on the first film and having adhered sides as in (c), on the outer surface of the second film having the absorption holes; and (e) adhering three sides of the third film, other than one side thereof, to the second film in the state of (d), thus manufacturing a packaging sheet for packaging the food including meat, fish, and vegetables.

Each of the films may comprise any one material selected from among polyvinyl chloride (PVC), polyester (PET), polyethylene (PE), polypropylene (PP), polyamide, ethylene-vinyl alcohol (EVOH), ethylene-vinyl acetate (EVA), polyvinylidene chloride (PVDC), polystyrene (PS), polyethylene terephthalate (PET), nylon (NY), polycarbonate (PC), acetyl cellulose, acetyl butyl cellulose, plastic composite films, and modified biodegradable films, which are harmless to the human body.

Each of the films may be any one selected from among a transparent film, a semi-transparent film, and an opaque film, and may have any one color selected from among various colors.

The biofluid absorption fabric may contain therein a superabsorbent, including Luquasorb FP 800, or a polymeric water absorbent, in a powder or granule form, in order to absorb food drips which are infiltrated thereinto.

In the method according to the present invention, the adhering the sides may be conducted through any one adhesion process selected from an adhesion process using thermal fusion, an adhesion process using high frequency fusion, an adhesion process using an adhesive, and an adhesion process using a double-sided tape.

The biofluid absorption fabric may be adhered and fixed on the inner surface of the film having the absorption holes or an inner surface of the film, which is positioned outward, through any one adhesion process selected from an adhesion process using thermal fusion, an adhesion process using high frequency fusion, an adhesion process using an adhesive, and an adhesion process using a double-sided tape.

The absorption holes may be formed in a plural number at predetermined intervals in an area of the half of the film, other than sides thereof, or in an area of the film, other than an area in contact with the biofluid absorption fabric. In addition, the present invention provides a packaging sheet product, manufactured using the aforementioned method.

### Advantageous Effects

According to the present invention, the packaging sheet is composed of three layers, between two layers of which a biofluid absorption fabric is disposed, so that food is separated from the biofluid absorption fabric at the time of packaging the food, and thereby, in a state in which the food does not come into direct contact with the biofluid absorption fabric, drips oozing from the food are absorbed into the biofluid absorption fabric through absorption holes, thus maintaining optimal freshness of the packaged food.

In addition, according to the present invention, the packaging sheet is composed of three layers, between two layers of which a biofluid absorption fabric is disposed, so that food is separated from the biofluid absorption fabric at the time of packaging the food, thereby preventing contact between food and drips oozing from the food, thus preventing the discoloration of the food and the degradation of the quality thereof for a long period of time.

In addition, according to the present invention, the packaging sheet is composed of three layers, between two layers of which a biofluid absorption fabric is disposed, thereby overcoming conventional problems in which a biofluid absorption fabric is manually placed in the packaging sheet, for example, burdens of time and personnel expense, and enabling the automation of a packaging process.

In addition, according to the present invention, the packaging sheet is composed of three layers, between two layers of which a biofluid absorption fabric is disposed, so that food is separated from the biofluid absorption fabric at the time of packaging the food, thereby solving conventional problems related to accidents in which a consumer does not notice the presence of a biofluid absorption fabric, which is typically provided under food, and cooks the fabric along with the food.

In addition, according to the present invention, the packaging sheet is composed of three colored layers, between two layers of which a biofluid absorption fabric is disposed, so that food is separated from the biofluid absorption fabric at the time of packaging the food, thereby covering the biofluid absorption fabric into which drips (biofluid) are absorbed to thus overcome an uncomfortable feeling attributable to the sight of such fabric.

In addition, according to the present invention, the packaging sheet is composed of three layers, between two layers of which a biofluid absorption fabric is disposed, and also, absorption holes for absorbing drips oozing from food are formed in the inner layer, and thus, in a state in which food does not come into direct contact with the biofluid absorption fabric, drips oozing from food are absorbed into the biofluid absorption fabric through the absorption holes, thereby preventing the excessive absorption of water from food and the rapid drying of food.

### DESCRIPTION OF DRAWINGS

FIG. 1 is a top plan view illustrating the first procedure in a process of manufacturing a packaging sheet for absorbing biofluid according to a first embodiment of the present invention;

FIG. 2 is a top plan view illustrating the second procedure in the process of manufacturing the packaging sheet for absorbing biofluid according to the first embodiment of the present invention;

FIG. 3 is a top plan view illustrating the third procedure in the process of manufacturing the packaging sheet for absorbing biofluid according to the first embodiment of the present invention;

FIG. 4 is a top plan view illustrating the fourth procedure in the process of manufacturing the packaging sheet for absorbing biofluid according to the first embodiment of the present invention;

FIG. 5 is a cross-sectional view illustrating the fourth procedure in the process of manufacturing the packaging sheet for absorbing biofluid according to the first embodiment of the present invention;

FIG. 6 is a top plan view illustrating the fifth procedure in the process of manufacturing the packaging sheet for absorbing biofluid according to the first embodiment of the present invention;

FIG. 7 is a cross-sectional view illustrating the fifth procedure in the process of manufacturing the packaging sheet for absorbing biofluid according to the first embodiment of the present invention;

FIG. 8 is a top plan view illustrating the sixth procedure in the process of manufacturing the packaging sheet for absorbing biofluid according to the first embodiment of the present invention;

FIG. 9 is a cross-sectional view illustrating the sixth procedure in the process of manufacturing the packaging sheet for absorbing biofluid according to the first embodiment of the present invention;

FIG. 10 is a top plan view illustrating the seventh procedure in the process of manufacturing the packaging sheet for absorbing biofluid according to the first embodiment of the present invention;

FIG. 11 is a cross-sectional view illustrating the seventh procedure in the process of manufacturing the packaging sheet for absorbing biofluid according to the first embodiment of the present invention;

FIG. 12 is a perspective view illustrating the packaging sheet for absorbing biofluid according to the first embodiment of the present invention;

FIG. 13 is a top plan view illustrating a process of manufacturing a packaging sheet for absorbing biofluid according to a second embodiment of the present invention;

FIG. 14 is a cross-sectional view illustrating the process of manufacturing the packaging sheet for absorbing biofluid according to the second embodiment of the present invention; and

FIG. 15 is a perspective view illustrating the packaging sheet for absorbing biofluid according to the second embodiment of the present invention.

### BEST MODE

Hereinafter, a detailed description will be given of a method of manufacturing a packaging sheet for absorbing biofluid and a packaging sheet product manufactured therewith, according to preferred embodiments of the present invention.

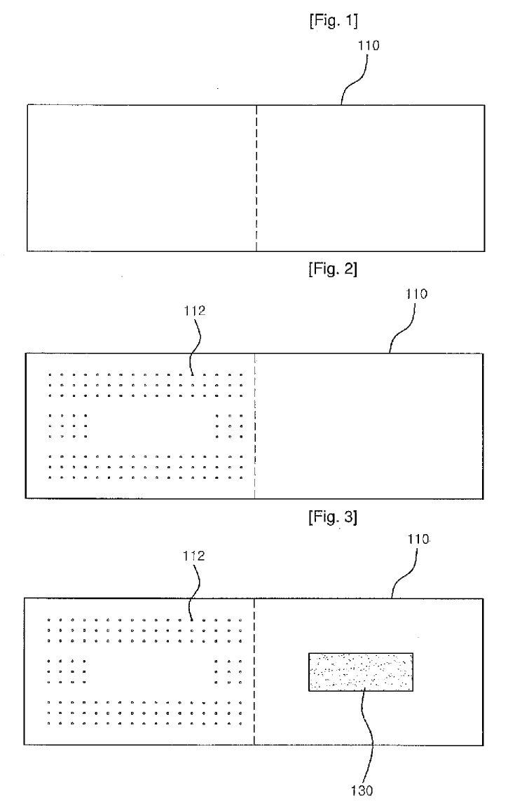

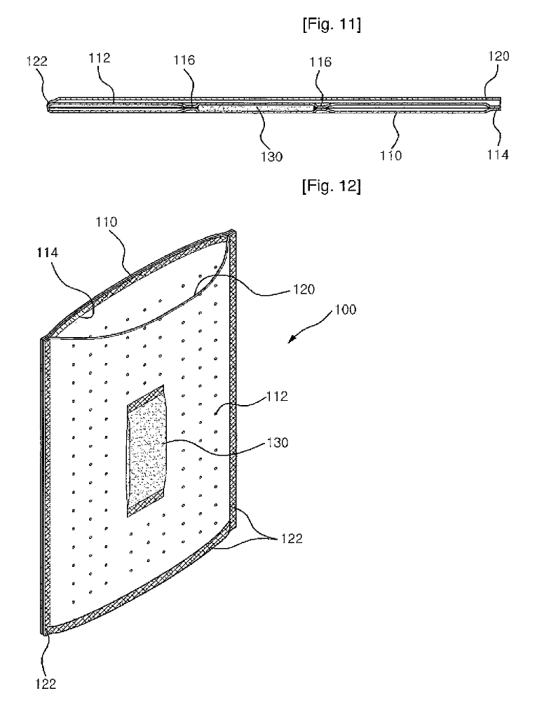

As shown in FIGS. 1 to 15, the packaging sheet 100 for absorbing biofluid according to a first embodiment of the present invention is manufactured by a series of procedures of forming a plurality of absorption holes 112 in a first half of a first film having a predetermined size, disposing a biofluid absorption fabric 130 for absorbing drips oozing from food on the second half of the first film 110, but not on the first half of the first film 110 having the absorption holes 112, folding the first film 110 in half such that the first half of the first film having the absorption holes 112 is positioned on the other second half of the first film 110 having the biofluid absorption fabric 130 disposed thereon, adhering the sides of the first film folded in half to thus form adhered sides 114, placing a second film 120 having the same size as the half of the first film 110 on the outer surface of the first half of the first film 110 folded in half and having the adhered sides 114, having the absorption holes 112, and adhering three sides of the second film, other than one side thereof, to the first film to thus form adhered sides 132, thereby manufacturing a packaging sheet for packaging food such as meat, fish, and vegetables.

As illustrated in FIG. 12, the packaging sheet 100 for absorbing biofluid, manufactured through the above procedures, according to the first embodiment of the present invention, has a configuration of three layers, two layers of which are formed by folding the first film 110 in half and are then sealed, and the biofluid absorption fabric 130 for absorbing drips oozing from food such as meat, fish and vegetables is adhered and fixed therebetween, and further, the sides of the second film 120 are adhered to the outer surface of the first half of the folded first film having the absorption holes 112, provided that one side thereof is open so as to define a space for packaging food such as meat, fish, and vegetables.

When food such as meat, fish, and vegetables is placed between the first half of the folded first film 110 having the absorption holes 112 and the second film 120 adhered to the outer surface thereof and is then packaged, the food, such as meat, fish, and vegetables, does not come into direct contact with the biofluid absorption fabric 130 due to the first half of the folded first film 110 having the absorption holes 112, thus preventing the excessive absorption of water from the food such as meat, fish, and vegetables. The drips oozing from the food such as meat, fish, and vegetables are absorbed into the biofluid absorption fabric 130, disposed and fixed between the first half and the second half of the first film 110 folded in half, via the absorption holes 112.

That is, the packaging sheet 100 for absorbing biofluid according to the first embodiment of the present invention has three layers, two layers of which are formed by folding the first film 110 in half. The first half of the first film 110 folded in half, corresponding to one layer of the above two layers, includes a plurality of absorption holes 112, and the second film 120, having the same size as the half of the first film 110, is placed on the outer surface of the first half of the folded first film having the absorption holes 112, after which three sides of the second film, other than one side thereof, are adhered to the first film, thereby manufacturing the packaging sheet 100 for packaging food such as meat, fish, and vegetables therein.

In the packaging sheet 100 for absorbing biofluid according to the first embodiment of the present invention, having three layers, as mentioned above, because the first half of the folded first film 110 having the absorption holes 112 is positioned between the second half of the folded first film 110 and the second film 120, corresponding to both outer layers, the food, such as meat, fish, and vegetables, is placed in the packaging space defined between the first half of the folded first film 110 having the absorption holes 112 and the second film 120 composed of a single layer and adhered to the outer surface thereof, and is then packaged.

In this way, in the packaging sheet 100 for absorbing biofluid according to the first embodiment of the present invention, when the food, such as meat, fish, and vegetables, is placed and packaged in the packaging space defined between the first half of the folded first film 110 having the absorption holes 112 and the second film 120 composed of a single layer and adhered to the outer surface thereof, drips oozing from the packaged food such as meat, fish, and vegetables are guided into the space defined between the first half and the second half of the first film 110 folded in half via the absorption holes 112 and are thus absorbed into the biofluid absorption fabric 130 disposed between the first half and the second half of the first film 110 folded in half.

Because the food, such as meat, fish, and vegetables packaged in the packaging space of the packaging sheet 100 for absorbing biofluid does not come into direct contact with the biofluid absorption fabric 130 due to the first half of the folded first film 110 having the absorption holes 112, only the drips guided into the space between the first half and the second half of the folded first film 110 via the absorption holes 112 are absorbed, and excessive absorption of water from the food, such as meat, fish, and vegetables, does not take place. Hence, excessive water absorption does not occur, thus maintaining the freshness of food such as meat, fish, and vegetables and enabling extended storage.

As described above, the packaging sheet 100 for absorbing biofluid may be manufactured by stacking the first film folded in half and the second film 120, or alternatively, the packaging sheet 100 for absorbing biofluid may be manufactured by stacking three films having the same size, which is described later.

Below, the process of manufacturing the packaging sheet 100 for absorbing biofluid according to the first embodiment of the present invention is more specifically described. Step (a) is a procedure for forming the absorption holes 112, through which drips oozing from food such as meat, fish, and vegetables are guided, in the first half of the first film 110. In step (a), as illustrated in FIG. 2, the plurality of absorption holes 112 is formed at predetermined intervals only in the first half of the first film 110, illustrated in FIG. 1.

In step (a), the absorption holes 112 may be formed in a plural number at predetermined intervals in the area of the film, other than the area in contact with the biofluid absorption fabric 130, as seen in FIGS. 2 to 12, or alternatively, absorption holes 212 may be formed in a plural number at predetermined intervals in the area of a film 210, other than sides thereof.

Step (b) is a procedure for disposing the biofluid absorption fabric 130. In step (b), as illustrated in FIG. 3, after the plurality of absorption holes 112 is formed at predetermined intervals only in the first half of the first film 110, as in step (a), the biofluid absorption fabric 130 for absorbing drips oozing from food (meat, fish, and vegetables) is disposed on the second half of the first film, but not on the first half thereof having the absorption holes 112.

The size of the biofluid absorption fabric 130 for absorbing drips oozing from food (meat, fish, and vegetables), disposed on the second half of the first film but not on the first half thereof having the absorption holes 112, as in step (b), varies depending on the type of food (meat, fish and vegetables) to be packaged. That is, in the case of food from which large amounts of drips are generated, a biofluid absorption fabric 130 having a large size is disposed. Conversely, in the case of food from which small amounts of drips are generated, a biofluid absorption fabric 130 having a small size is disposed.

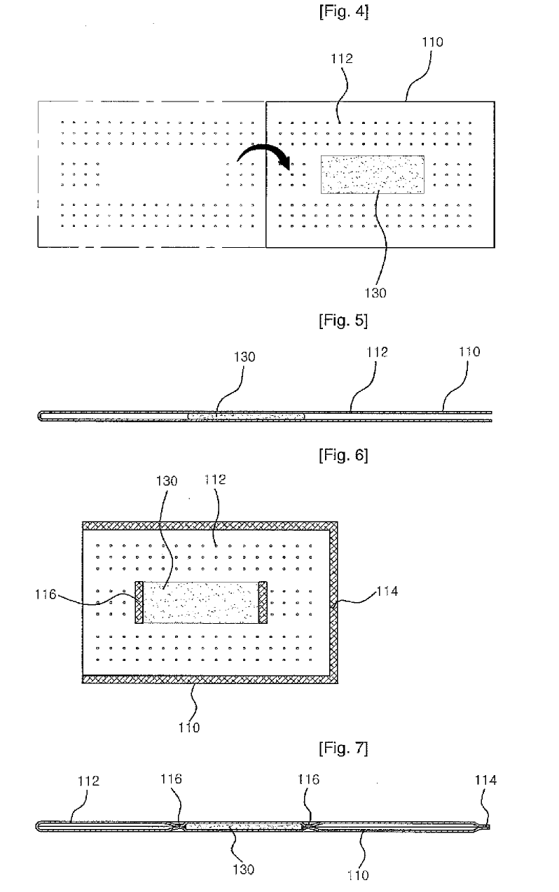

Step (c) is a procedure for folding the first film 110, composed of a single layer, in half. In Step (c), as illustrated in FIGS. 4 and 5, the first film 110 is folded in half such that the first half of the first film 110 having the absorption holes 112 is positioned on the other second half thereof, on which the biofluid absorption fabric 130 is disposed, thus forming two layers of the packaging sheet.

Step (d) is a procedure for adhering the first half and the second half of the first film 110 folded in half, as in step (c). In step (d), as illustrated in FIGS. 6 and 7, the sides of the folded first film 110 are adhered. The adhered sides 114 are formed by adhering only three sides, except for the side corresponding to a folded portion.

In step (d), the sides of the folded first film 110 may be adhered through any one adhesion process selected from among an adhesion process using thermal fusion, an adhesion process using high frequency fusion, an adhesion process using an adhesive, and an adhesion process using a double-sided tape.

Further, in the case where there is a need to fix the biofluid absorption fabric 130 disposed between the first half and the second half of the folded first film 110, the biofluid absorption fabric may be attached to the inner surface of the first half of the folded first film 110 having the absorption holes 112 or the inner surface of the second half thereof, which is positioned outward, through any one adhesion process selected from among an adhesion process using thermal fusion, an adhesion process using high frequency fusion, an adhesion process using an adhesive, and an adhesion process using a double-sided tape. Reference numeral 116 designates absorption fabric-adhered sides, where both sides of the biofluid absorption fabric 130 are adhered.

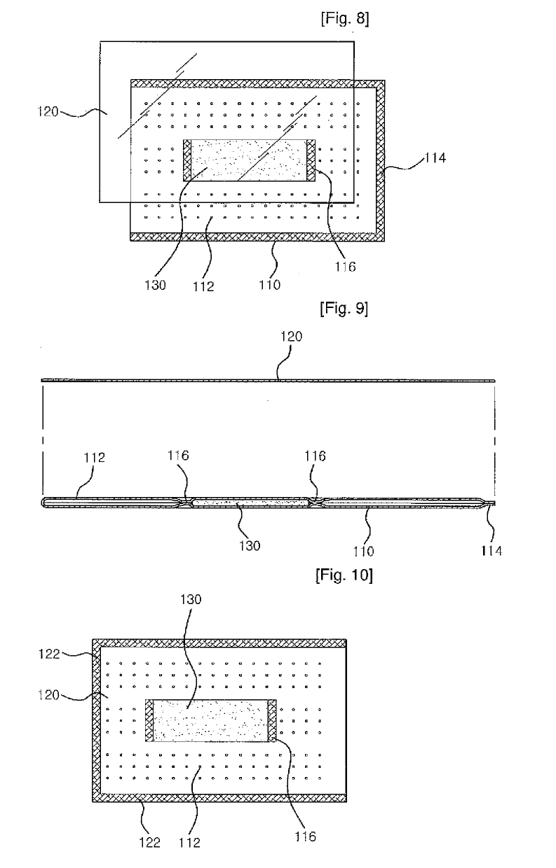

Steps (e) and (f) are procedures for forming the packaging space for packaging food such as meat, fish and vegetables. In step (e), as illustrated in FIGS. 8 and 9, the second film 120 is placed on the outer surface of the first half of the first film 110 folded in half and having the adhered sides, having the absorption holes 112.

The second film 120, placed on the outer surface of the first half of the first film 110 folded in half and having the adhered sides, having the absorption holes 112, has the same size as the half of the first film 110.

In step (f), in the state in which the second film 120 is placed on the outer surface of the first half of the first film 110 folded in half and having the adhered sides, having the absorption holes 112, as in step (e), three sides of the second film, other than one side thereof, are adhered to the first film, thus manufacturing the packaging sheet 110 for packaging food such as meat, fish, and vegetables. Reference numeral 122 designates the adhered sides of the second film 120 adhered to the first film 110.

In the present invention, the films 110, 120 may be formed of any one material selected from among polyvinyl chloride (PVC), polyester (PET), polyethylene (PE), polypropylene (PP), polyamide, ethylene-vinyl alcohol (EVOH), ethylene-vinyl acetate (EVA), polyvinylidene chloride (PVDC), polystyrene (PS), polyethylene terephthalate (PET), nylon (NY), polycarbonate (PC), acetyl cellulose, acetyl butyl cellulose, plastic composite films, and modified biodegradable films, which are harmless to the human body.

In the packaging sheet 100 for absorbing biofluid according to the present invention, the films 110, 120 may be any one selected from among a transparent film, a semi-transparent film, and an opaque film, and the films 110, 120 may have any one color selected from various colors, including red, blue, pink, wine, and brown. In particular, films 110, 120 having various colors function to conceal the bloody color or dirt drips (biofluid) oozing from fowl or fish to thus increase the marketability of food.

Also, the biofluid absorption fabric 130 may contain therein a superabsorbent, for example, Luquasorb FP 800, or a polymeric water absorbent, in the form of powder or granules, in order to absorb food drips which are infiltrated thereinto.

Luquasorb FP 800, which is the superabsorbent, is a trade name belonging to BASF, and such a superabsorbent is composed of crosslinked polyacrylates able to absorb and link a large amount (at least 500 times of the weight of the absorbent) of liquid, and functions to absorb and crystallize liquid such as drips or water remaining in the packaging sheet. Thereby, the freshness of some food products very sensitive to water may be maintained for a longer time.

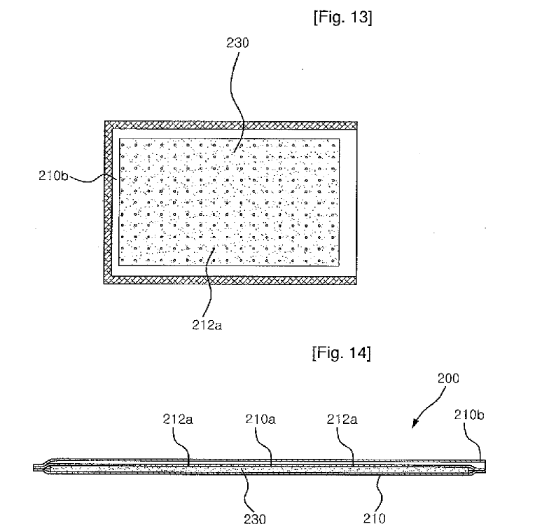

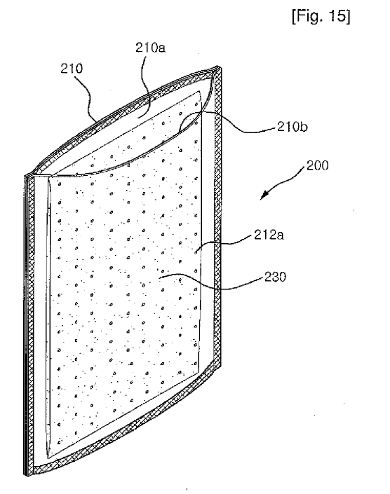

FIG. 13 is a top plan view illustrating a process of manufacturing a packaging sheet for absorbing biofluid according to a second embodiment of the present invention, FIG. 14 is a cross-sectional view illustrating the process of manufacturing the packaging sheet for absorbing biofluid according to the second embodiment of the present invention, and FIG. 15 is a perspective view illustrating the packaging sheet for absorbing biofluid according to the second embodiment of the present invention.

As shown in FIGS. 13 to 15, in the method of manufacturing the packaging sheet for absorbing biofluid according to the second embodiment of the present invention, the packaging sheet has three layers, as in the method of manufacturing the packaging sheet for absorbing biofluid according to the first embodiment of the present invention, as seen in FIGS. 1 to 12. However, the method of manufacturing the packaging sheet for absorbing biofluid according to the second embodiment of the present invention is different, in terms of the use of three films 210, 210a, 210b having the same size, from the method illustrated in FIGS. 1 to 12.

That is, as seen in FIGS. 13 to 15, the method of manufacturing the packaging sheet for absorbing biofluid according to the second embodiment of the present invention includes (a) disposing a biofluid absorption fabric 230 for absorbing drips oozing from food on a first film 210 having a predetermined size, (b) forming a plurality of absorption holes 212a in a second film 210a having the same size as the first film 210 used in step (a) and then placing the second film on the first film so that the biofluid absorption fabric 230 is disposed between the first and second films, (c) adhering the sides of the first and second films 210, 210a in the state of step (b), (d) placing a third film 210b having the same size as the second film 210a on the outer surface of the second film having the absorption holes 212a and having the sides adhered to the first film as in (c), and (e) adhering three sides of the third film other than one side thereof to the second film in the state of (d), thus manufacturing a packaging sheet 200 for packaging food such as meat, fish, and vegetables.

That is, as seen in FIGS. 13 and 14, the packaging sheet 200 for absorbing biofluid according to the second embodiment of the present invention comprises three films 210, 210a, 210b having the same size, in which the second film 210a, which is disposed as an intermediate layer, is formed with the absorption holes 212a for guiding drips oozing from food such as meat, fish and vegetables, and all of the sides of the second film 210a having the absorption holes 212a and the first film 210 disposed as a lower layer are adhered and sealed. On the second film 210a having the absorption holes 212a, the third film 210b is placed, after which three sides of the third film, other than one side thereof, are adhered to the second film, thereby defining a packaging space between the third film 210b disposed as an upper layer and the second film 210a having the absorption holes 212a to package food such as meat, fish, and vegetables.

In the packaging sheet 200 for absorbing biofluid according to the second embodiment of the present invention, comprising three films 210, 210a, 210b composed of three layers having the same size, when food such as meat, fish, and vegetables is placed and packaged in the packaging space, drips oozing from the packaged food such as meat, fish, and vegetables are guided into the space between the second film 210a disposed as the intermediate layer and the first film 210 disposed as the lower layer through the absorption holes 212a formed in the second film and are thus absorbed into the biofluid absorption fabric 230.

In the packaging sheet 200 for absorbing biofluid according to the second embodiment of the present invention, when the food such as meat, fish, and vegetables, packaged in the packaging space, does not come into direct contact with the biofluid absorption fabric 230 due to the second film 210a having the absorption holes 212a disposed as the intermediate layer, excessive water absorption from the food such as meat, fish, and vegetables does not occur. Accordingly, because excessive water absorption does not occur, the freshness of the food, such as meat, fish, and vegetables, may be maintained, consequently enabling extended storage.

The packaging sheet 100, 200 for absorbing biofluid according to the present invention prevents contact between food and drips oozing from the food, thus maintaining optimal food freshness and preventing discoloration. Further, when the food is packaged, the food is separated from the biofluid absorption fabric, thereby solving conventional problems in which a consumer does not notice the presence of the absorption fabric and thus cooks the fabric along with the food.

Although the preferred embodiments of the present invention have been disclosed for illustrative purposes, those skilled in the art will appreciate that various modifications, additions and substitutions are possible within the technical spirit of the invention.

1. A method of manufacturing a packaging sheet for absorbing biofluid, suitable for absorbing drips oozing from food, including meat, fish, and vegetables, packaged therein, comprising:
(a) forming a plurality of absorption holes in a first half of a first film having a predetermined size;
(b) disposing a biofluid absorption fabric for absorbing drips oozing from the food on a second half of the first film, but not on the first half of the first film having the absorption holes formed as in (a);
(c) folding the first film in half so that the first half of the first film having the absorption holes is positioned on the second half of the first film on which the biofluid absorption fabric is disposed, as in (b);
(d) adhering sides of the first film folded in half as in (c);
(e) placing a second film, having a same size as the half of the first film, on an outer surface of the first half of the first film folded in half and having the adhered sides as in (d), having the absorption holes; and
(f) adhering three sides of the second film, other than one side thereof, to the first film in a state of (e), thus manufacturing a packaging sheet for packaging the food including meat, fish, and vegetables.

2. The method according to claim 1, wherein each of the films comprises any one material selected from among polyvinyl chloride (PVC), polyester (PET), polyethylene (PE), polypropylene (PP), polyamide, ethylene-vinyl alcohol (EVOH), ethylene-vinyl acetate (EVA), polyvinylidene chloride (PVDC), polystyrene (PS), polyethylene terephthalate (PET), nylon (NY), polycarbonate (PC), acetyl cellulose, acetyl butyl cellulose, plastic composite films, and modified biodegradable films, which are harmless to a human body.

3. The method according to claim 2, wherein each of the films is any one selected from among a transparent film, a semi-transparent film, and an opaque film.

4. The method according to claim 3, wherein each of the films has any one color selected from among various colors.

5. The method according to claim 1, wherein the biofluid absorption fabric contains therein a superabsorbent, including Luquasorb FP 800, or a polymeric water absorbent, in a powder or granule form, in order to absorb food drips which are infiltrated thereinto.

6. The method according to claim 1, wherein the adhering the sides is conducted through any one adhesion process selected from an adhesion process using thermal fusion, an adhesion process using high frequency fusion, an adhesion process using an adhesive, and an adhesion process using a double-sided tape.

7. The method according to claim 1, wherein the biofluid absorption fabric is adhered and fixed on an inner surface of the first half of the first film folded in half, having the absorption holes, or an inner surface of the second half thereof, which is positioned outward, through any one adhesion process selected from an adhesion process using thermal fusion, an adhesion process using high frequency fusion, an adhesion process using an adhesive, and an adhesion process using a double-sided tape.

8. The method according to claim 1, wherein the absorption holes are formed in a plural number at predetermined intervals in an area of the first half of the first film, other than the sides thereof.

9. The method according to claim 1, wherein the absorption holes are formed in a plural number at predetermined intervals in an area of the first film, other than an area in contact with the biofluid absorption fabric.

10. A method of manufacturing a packaging sheet for absorbing biofluid, suitable for absorbing drips oozing from food, including meat, fish, and vegetables, packaged therein, comprising:
(a) disposing a biofluid absorption fabric for absorbing drips oozing from the food on a first film having a predetermined size;
(b) forming a plurality of absorption holes in a second film having a same size as the first film used in (a), and then placing the second film on the first film so that the biofluid absorption fabric is disposed between the first film and the second film;
(c) adhering sides of the first film and the second film in a state of (b);
(d) placing a third film, having a same size as the second film placed on the first film and having adhered sides as in (c), on an outer surface of the second film having the absorption holes; and
(e) adhering three sides of the third film, other than one side thereof, to the second film in a state of (d), thus manufacturing a packaging sheet for packaging the food including meat, fish, and vegetables.

11. The method according to claim 10, wherein each of the films comprises any one material selected from among polyvinyl chloride (PVC), polyester (PET), polyethylene (PE), polypropylene (PP), polyamide, ethylene-vinyl alcohol (EVOH), ethylene-vinyl acetate (EVA), polyvinylidene chloride (PVDC), polystyrene (PS), polyethylene terephthalate (PET), nylon (NY), polycarbonate (PC), acetyl cellulose, acetyl butyl cellulose, plastic composite films, and modified biodegradable films, which are harmless to a human body.

12. The method according to claim 11, wherein each of the films is any one selected from among a transparent film, a semi-transparent film, and an opaque film.

13. The method according to claim 12, wherein each of the films has any one color selected from among various colors.

14. The method according to claim 10, wherein the biofluid absorption fabric contains therein a superabsorbent, including Luquasorb FP 800, or a polymeric water absorbent, in a powder or granule form, in order to absorb food drips which are infiltrated thereinto.

15. The method according to claim 10, wherein the adhering the sides is conducted through any one adhesion process selected from an adhesion process using thermal fusion, an adhesion process using high frequency fusion, an adhesion process using an adhesive, and an adhesion process using a double-sided tape.

16. The method according to claim 10, wherein the biofluid absorption fabric is adhered and fixed on an inner surface of the second film having the absorption holes or an inner surface of the first film, which is positioned outward, through any one adhesion process selected from an adhesion process using thermal fusion, an adhesion process using high frequency fusion, an adhesion process using an adhesive, and an adhesion process using a double-sided tape.

17. The method according to claim 10, wherein the absorption holes are formed in a plural number at predetermined intervals in an area of the second film, other than sides thereof.

18. The method according to claim 10, wherein the absorption holes are formed in a plural number at predetermined intervals in an area of the second film, other than an area in contact with the biofluid absorption fabric.

19. A packaging sheet product, manufactured using the method of claim 1.
